(19) United States
(12) Patent Application Publication
(10) Pub. No.: US 2005/0123235 A1
(43) Pub. Date: Jun. 9, 2005

(54) Optical switch allowing multi-channelization in which plural optical path changing elements are arranged with ease and high-accuracy, and facilitating heating of optical path changing elements

(75) Inventor: Tetsuo Ikegame, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 11/002,165

(22) Filed: Dec. 1, 2004

(30) Foreign Application Priority Data
Dec. 5, 2003 (JP) 2003-408334

(51) Int. Cl. G02B 6/26

(52) U.S. Cl. 385/18

(57) ABSTRACT

In an optical switch according to the present invention, a galvo plate is caused to abut against a base plate on its mount portions at the both ends, and in addition, abutting sections formed at portions near galvano-mirrors are also caused to abut against the base plate. As a result, heat transfer from the galvo plate to the base plate is improved, and heat in the galvano-mirrors, particularly heat in its drive circuit and heat due to a laser, can be dissipated to the base plate. This allows the implementation of multi-channelization in which a plurality of optical path changing elements are arranged with ease and high-accuracy, and also facilitates the heating of the optical path changing elements.

This application claims benefit of Japanese Application No. 2003-408334 filed in Japan on Dec. 5, 2003, the contents of which are incorporated by this reference.

### BACKGROUND OF THE INVENTION

1. Field of the Invention

The present invention relates to an optical switch for switching among optical paths, used in optical communications or the like.

2. Description of the Related Art

Hitherto, the optical switch used for optical communications or the like has been incorporated into a device that enters light for optical communications emitted from one or a plurality of input optical fibers into desired output optical fibers by switching among a plurality of optical paths using optical path switching elements (see Japanese Unexamined Patent Application Publication No. 2001-174724 for example).

FIG. 12 is a construction view of the above-described conventional optical switch. FIG. 13 is plan view showing an example of mirror arrays in a micro electro-mechanical system (MEMS) used for the conventional optical switch.

As shown in FIG. 12, an optical switch 200 comprises input optical fiber arrays 212, an input lens array 214, a first MEMS mirror array 218, a second MEMS mirror array 222, an output lens array 226, and output optical fiber arrays 228. Here, for the sake of simplifying explanation, the input optical fiber arrays 212 and the output optical fiber arrays 228 are represented by four input optical fiber arrays 212a to 212d and four output optical fiber arrays 228a to 228d, respectively.

As shown in FIG. 13, a mirror array 410 constituting the first MEMS mirror array 218 or the second MEMS mirror array 222 is formed by arranging, in an array form, inclined mirrors 412 that are each mounted on a spring 414, on a base 416. Also, the inclined mirrors 412 are adapted to be controlled by respective electrodes (not shown).

Here, a brief description is made on the operation of the optical switch 200 having the first MEMS mirror array 218 and the second MEMS mirror array 222 each having the mirror array 410 as described above.

The optical switch 200 receives an optical signal 208 via the plurality of input optical fiber arrays 212. The input optical fiber arrays 212 send the optical signal 208 to the input lens array 214 serving as collimating lenses. The input lens array 214 produces pencil beams 216a to 216d out of the optical signal 208. Here, the pencil beams 216a to 216d are produced out of the signal conveyed by the input optical fiber arrays 212a to 212d.

The first MEMS mirror array 218 receives the beam 216. The first MEMS mirror array 218 reflects in accordance with the inclination angle of each mirror element, and is selectively directed to a specified mirror element in the second MEMS mirror array 222. For example, the pencil beam 216a produces beams from a reflected beam 220a to a reflected beam 220a′. Likewise, the pencil beam 216d produces beams from a reflected beam 220d to a reflected beam 220d′. These beams are received by the mirror elements of the second MEMS mirror array 222, and are directed as beams 224 to the output lens array 226. The output optical fiber arrays 228 receive light converged by the output lens array 226, and transmit it as an optical signal 229.

In the optical switch 200, each output fiber is mapped, in a one-to-one relationship, to a respective one of the mirrors in the output mirror array. This requires single mode fibers. This is because the numerical aperture necessary for input beams and output beams to coaxially match to the axis of the optical fiber in order to restrict the power loss to a low value, is small.

As described above, the optical switch 200 has the input lens array 214, which receives an optical signal from the plurality of input optical fiber arrays 212. The input lens array 214 comprises a plurality of lens elements, and each of the lens elements directs an optical signal to the MEMS mirror arrays 218 and 222. In other words, light is converged. These mirror arrays each have a plurality of mirror elements, and each of the elements inclines about one or a plurality of rotational axes when a control signal is applied to a desired mirror element.

Thus, the optical signal can be directed to various output optical fiber arrays 228 along various paths. As shown in FIG. 13, each of the MEMS mirror arrays 218 and 222 is configured so that a plurality of movable mirrors that are two-dimensionally arranged on a main surface by semiconductor process are integrally formed.

### SUMMARY OF THE INVENTION

According to the present invention, there is provided an optical switch including a first plate having first mounting surfaces and first abutting surfaces that are provided on a first side, a second plate having second mounting surfaces and second abutting surfaces that are provided on a second side, each of the second mounting surfaces abutting against a respective one of the first mounting surfaces and each of the second abutting surfaces abutting against a respective one of the first abutting surfaces to fix the first plate and the second plate, and a plurality of optical path selecting elements mounted on the first plate and the second plate.

Other features and advantages of the present invention will become sufficiently apparent in the following description.

### BRIEF DESCRIPTION OF THE DRAWINGS

FIG. 1 to FIG. 11 relate to an embodiment of the present invention.

FIG. 1 is a perspective view showing the external appearance of an optical switch according to an embodiment of the present invention;

FIG. 2 is a perspective view of the top surface of the galvo plate in FIG. 1;

FIG. 3 is a perspective view of the bottom surface of the galvo plate in FIG. 1;

FIG. 4 is a top view of the optical switch in FIG. 1;

FIG. 5 is an exploded development view of the optical switch in FIG. 1;

FIG. 6 is a sectional view taken along a line A-A in FIG. 4;

FIG. 7 is a sectional view taken along a line B-B in FIG. 4;

FIG. 8 is a diagram explaining optical paths of the optical switch in FIG. 1;

FIG. 9 is a perspective view showing the external appearance of the galvano-mirror in FIG. 1;

FIG. 10 is an exploded development view of the galvano-mirror in FIG. 9;

FIG. 11 is an exploded development view of the optical deflector in FIG. 10;

FIG. 12 is a construction view of a conventional optical switch; and

FIG. 13 is plan view showing an example of mirror arrays of micro electromechanical system (MEMS) used for the conventional optical switch.

### DETAILED DESCRIPTION OF THE PREFERRED EMBODIMENTS

### Embodiment

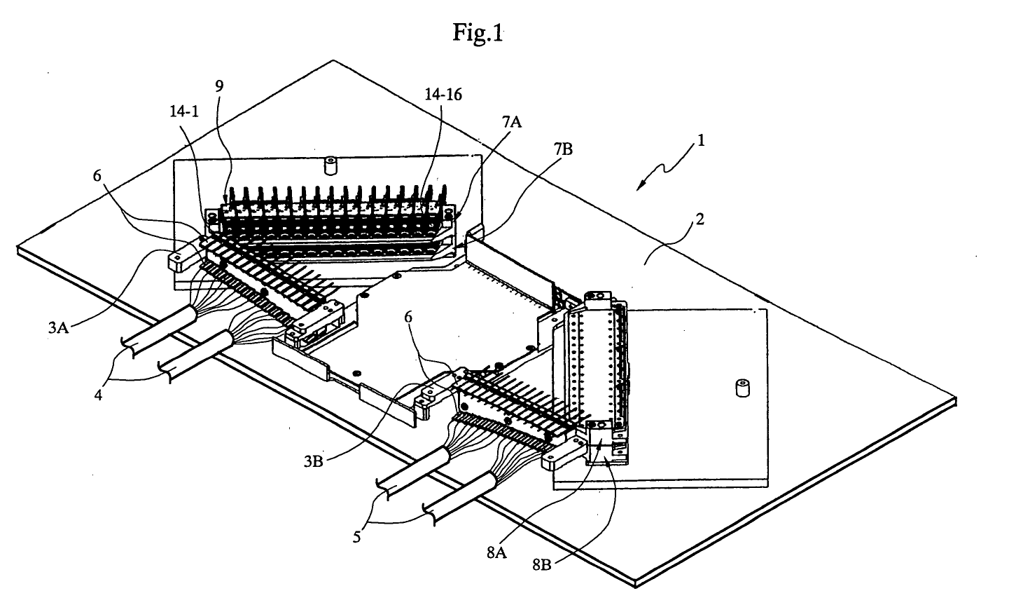

FIG. 1 shows an example of an optical switch 1 in which sixteen galvano-mirrors 9, each serving as an optical path selecting element, is fixed to each one of four galvo plates 7A, 7B, 8A, and 8B, and in which thirty-two input channels and thirty-two output channels are formed by arranging the aforementioned four galvo plates 7A, 7B, 8A, and 8B in two-stage and a substantially truncated chevron configuration. In FIG. 1, thirty-two galvano-mirrors fixed to each of the galvo plates 8A and 8B are omitted from illustration.

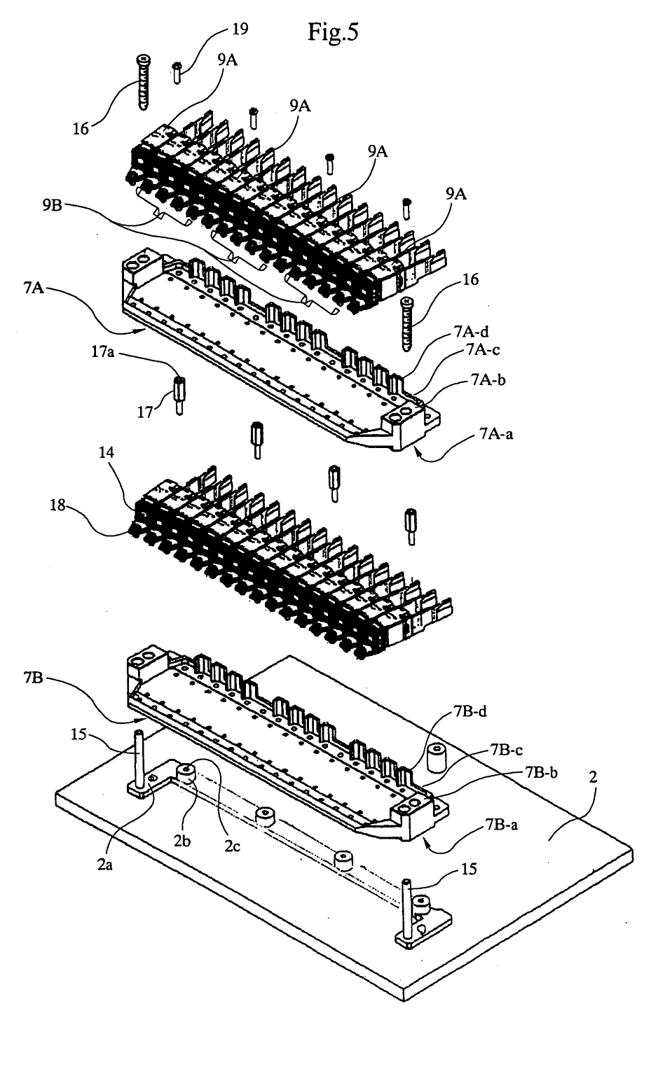

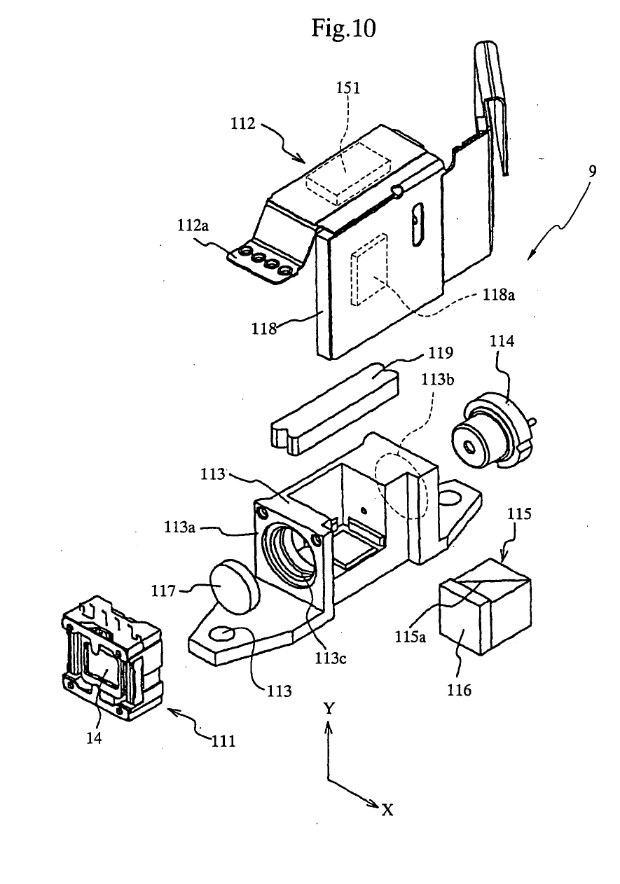

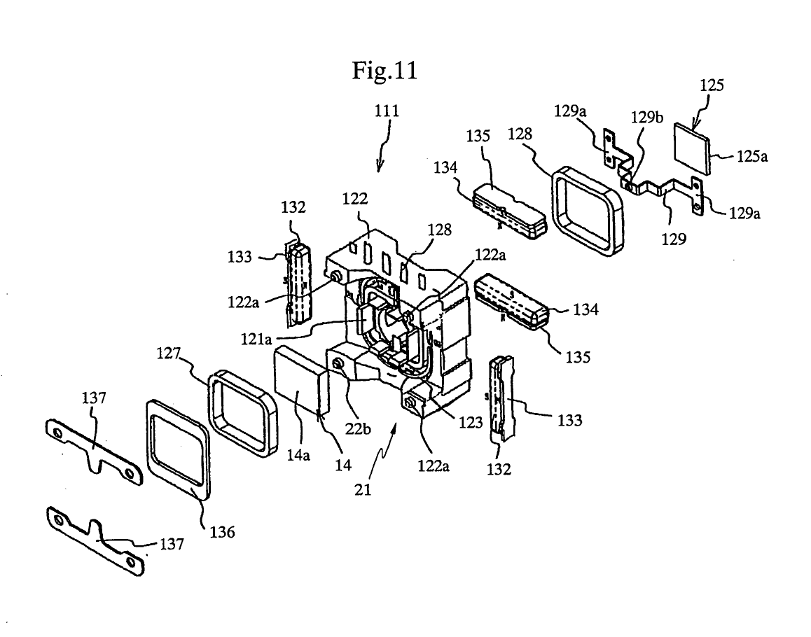

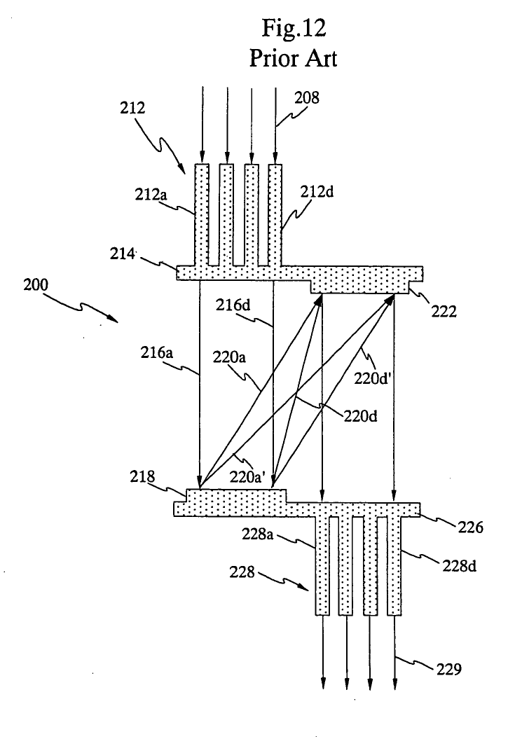

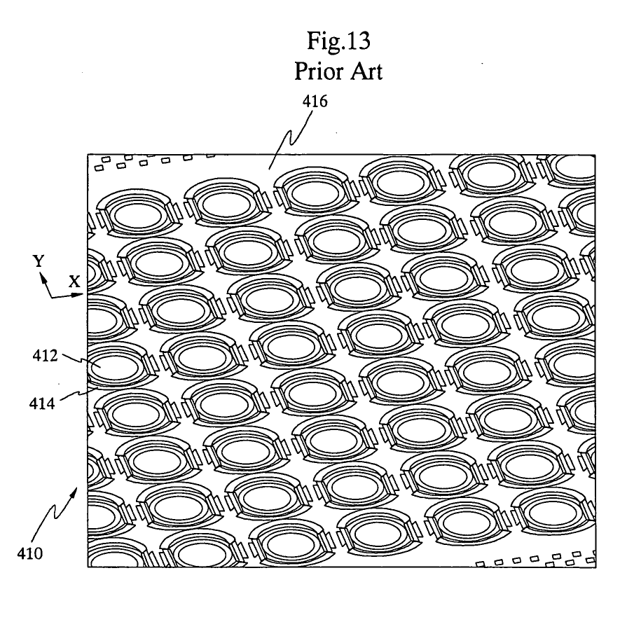

Hereinafter, detailed construction of the optical switch 1 according to the embodiment of the present invention will be described with reference to FIGS. 1 to 11.

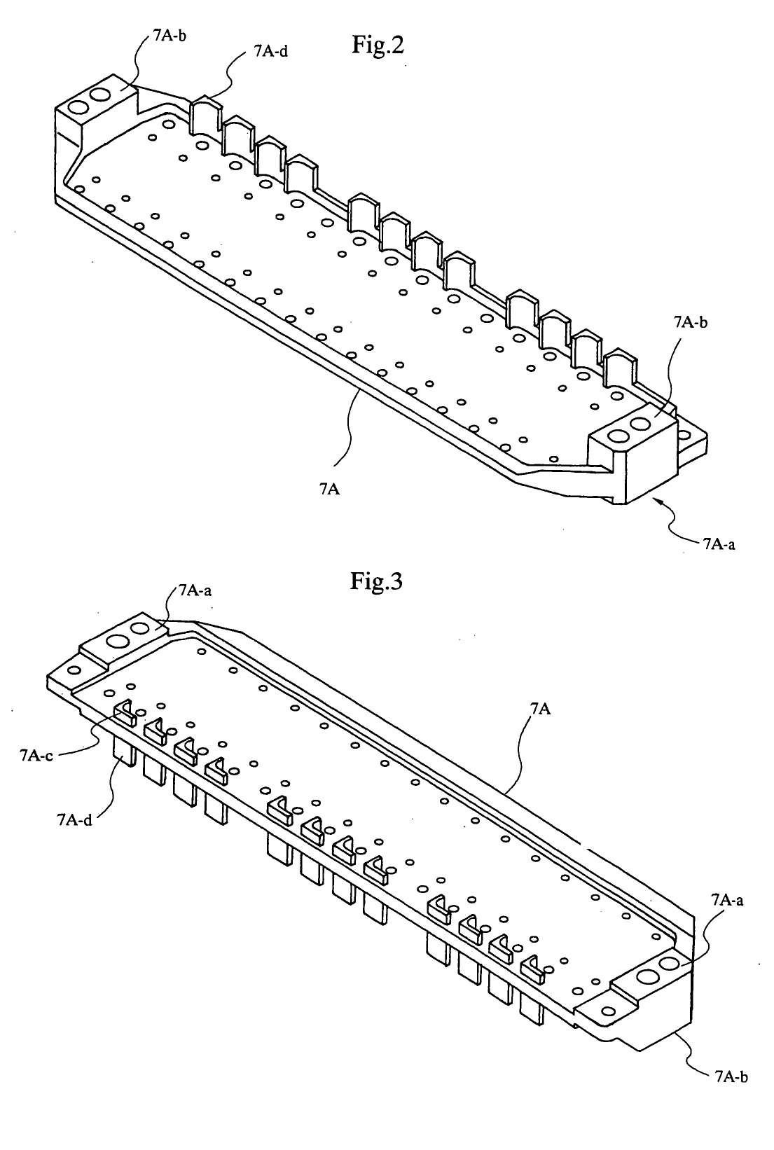

As shown in FIGS. 2 and 3, the galvo-plate 7A has mounting surfaces 7A-a provided on the bottom surfaces at its both ends, and also mounting surfaces 7A-b provided on the top surfaces at its both ends. Twelve abutting sections 7A-c are provided between the mounting surfaces 7A-a at the both ends, and also similar twelve abutting sections 7A-d are provided between the mounting surfaces 7A-b at the both ends. The mounting surfaces 7A-a at the both ends and the bottom surfaces of the twelve abutting sections 7A-c are mutually flush. Likewise, the mounting surfaces 7A-b at the both ends and the top surfaces of the twelve abutting sections 7A-d are mutually flush.

Here, because the four galvo plates 7A, 7B, 8A, and 8B have the same shape, the explanation of the galvo plates 8A and 8B is omitted from explanation.

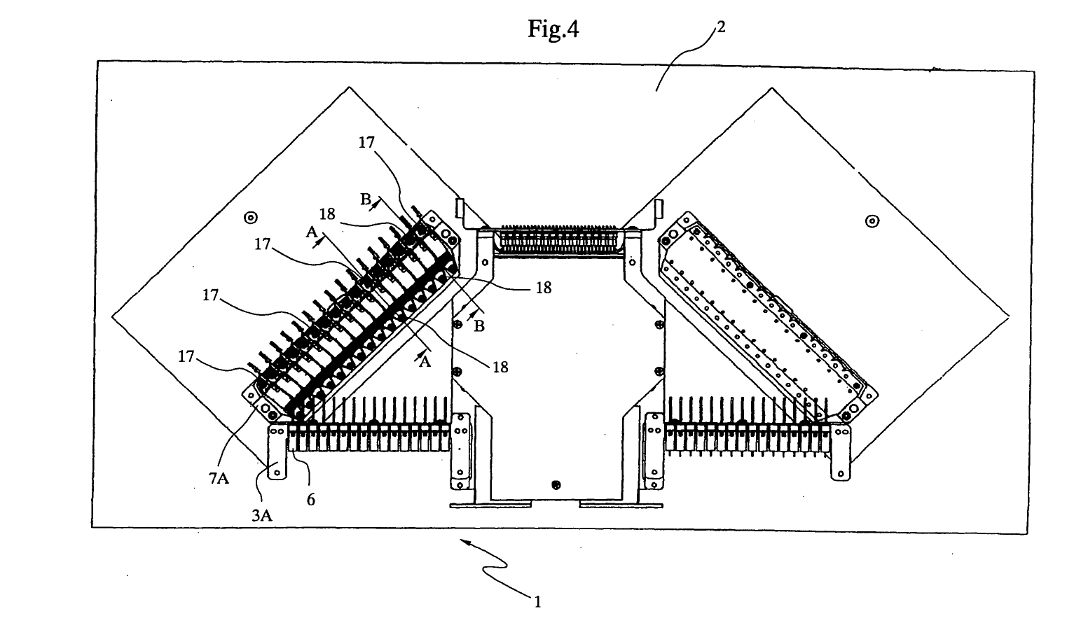

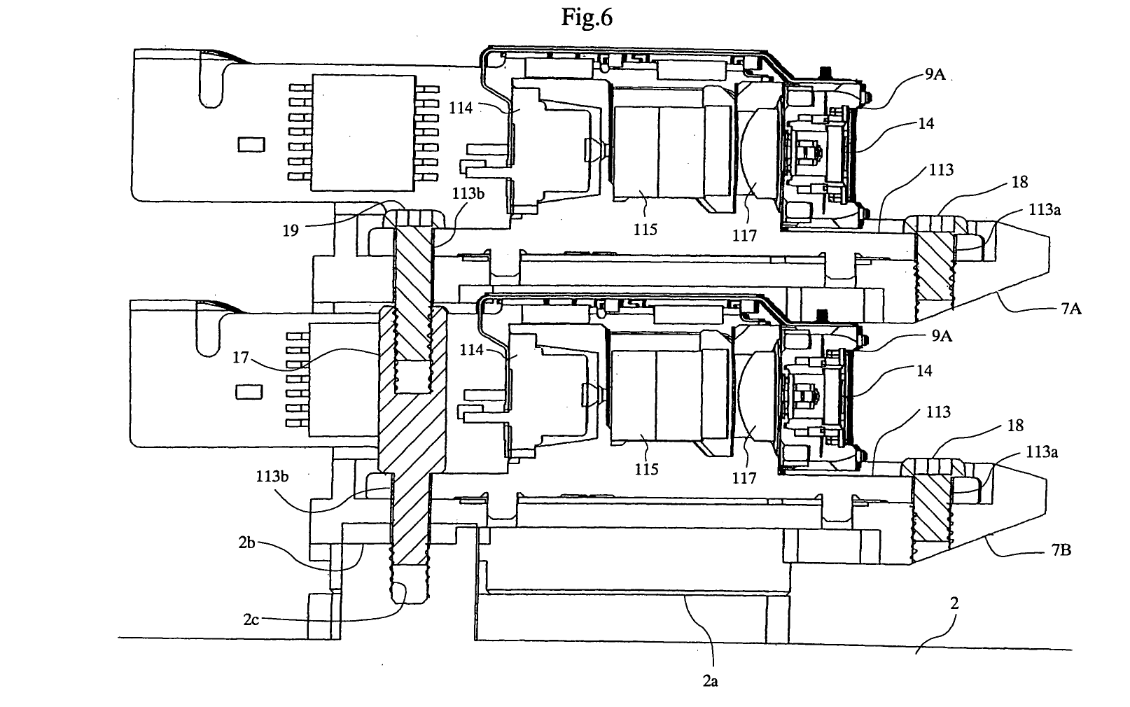

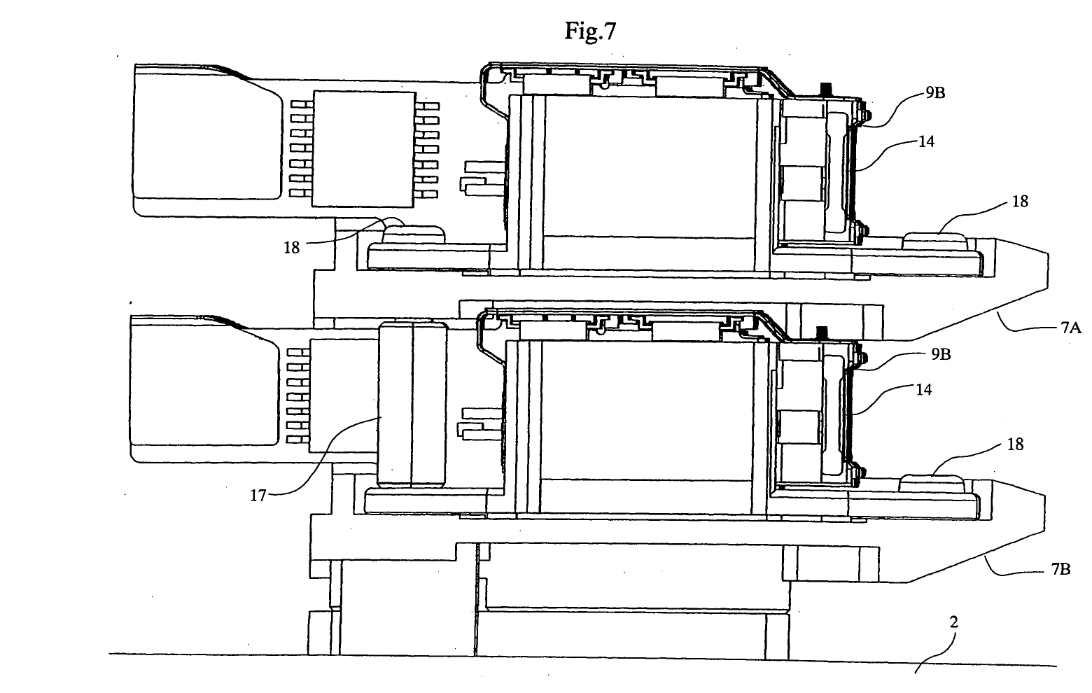

As shown in FIGS. 4 to 7, out of sixteen galvano-mirrors 9 each serving as an optical path changing element, twelve galvano-mirrors 9B exclusive of four galvano-mirrors 9A, are fixed to the four galvo plates 7A, 7B, 8A, and 8B with the front and back of each of the galvano-mirrors fastened by two screws 18 (see FIG. 7). The front side (mirror 14 side) of the galvano-mirror 9A is fixed to the galvo plate 7A by a screw 18 using one of two holes formed at the front and back of the housing 113 of the galvano-mirror 9A. On the other hand, the back side of the galvano-mirror 9A is not fixed by a screw 18, and it is to be fixed to the base plate 2 when the galvano-mirror 9A is fixed at a later time (see FIG. 6).

The galvano-mirror 9 has a mirror 14. The mirror 14 is configured to be inclinable about an X-axis and Y-axis, which are two axes orthogonally intersecting each other and parallel to the reflecting surface of the mirror 14. The detailed construction of the galvano-mirror 9 is described later.

Then, four galvo plates 7A, 7B, 8A, and 8B on each of which sixteen galvano-mirrors are fixed, are fixed to the base plate 2.

Two positioning pins 15 are pressed into the mounting sections 2a of the base plate 2, and the holes at the both ends of the galvo plate 7B are fitted to the positioning pins 15, whereby the mounting surfaces 7B-a on the bottom surfaces at the both ends of the galvo plate 7B are caused to abut against the mounting sections 2a and assembled thereto.

Next, four galvano-mirrors 9B are fixed to the galvo plate 7B by fixing four studs 17 to screw holes 2c formed in four posts provided to the base plate 2 through the holes 113b in the back sides of the galvano-mirrors 9B, of which back sides have not been fixed by the screws 18, and also the galvo plate 7B is fixed to the base plate 2. At this time, the bottom surfaces of the abutting sections 7B-c provided on the bottom surface of the galvo plate 7B also abut against the mounting sections 2a.

Then, the galvo plate 7A is assembled onto the galvo plate 7B. The mounting surfaces 7A-a on the bottom surfaces at the both ends of the galvo plate 7A are caused to abut against the mounting surfaces 7A-b on the top surfaces at the both ends of the galvo plate 7B. Simultaneously, the bottom surfaces of the abutting sections 7A-c are caused to abut against the top surfaces of the 7B-d. The galvo plate 7A is also fitted to and positioned by the positioning pins 15 and assembled to the galvo plate 7B. Then, the galvo plates 7A and 7B are simultaneously fixed to the base plate 2 by two screws 16.

Thereafter, four galvano-mirrors 9B are fixed to the galvo plate 7A by fixing four screws 19 to screw holes 17a formed in the top surface of each of the four studs 17 through the holes 113b in the back sides of the four galvano-mirrors 9A, of which back sides have not been fixed by the screw 18, and the holes of the galvo plate 7A, and also the galvo plate 7A is fixed to the base plate 2. At this time, the upper end of each of the studs 17 is not in contact with the rear surface of the galvo plate 7A with a little space therebetween.

As described above, the galvo plates 7A and 7B, on each of which sixteen galvano-mirrors 9 are fixed, are fixed to the base plate 2 in a two-stage manner. Similarly, the galvo plates 8A and 8B, on each of which sixteen galvano-mirrors 9 are fixed, are fixed to the base plate 2 in a two-stage manner.

To the collimating plates 3A that are fixed to the base plate 2, sixteen collimating lenses 6 and sixteen end faces of the input optical fibers 4 are fixed on the upper and lower sides of the collimating plates 3A, respectively. Thereby, light beams emitted from the input optical fibers 4 are collimated by the respective collimating lenses 6, and respectively head toward the mirrors 14 opposed to the galvano-mirrors 9.

Sixteen collimating lenses 6 and sixteen end faces of the output optical fibers 5 are fixed to collimating plates 3B on their upper and lower sides, respectively. Thereby, light beams reflected from the mirrors 14 of the galvano-mirrors 9 enter the respective collimating lenses 6, and after having been converged, enter the respective output optical fibers 5 to propagate therethrough.

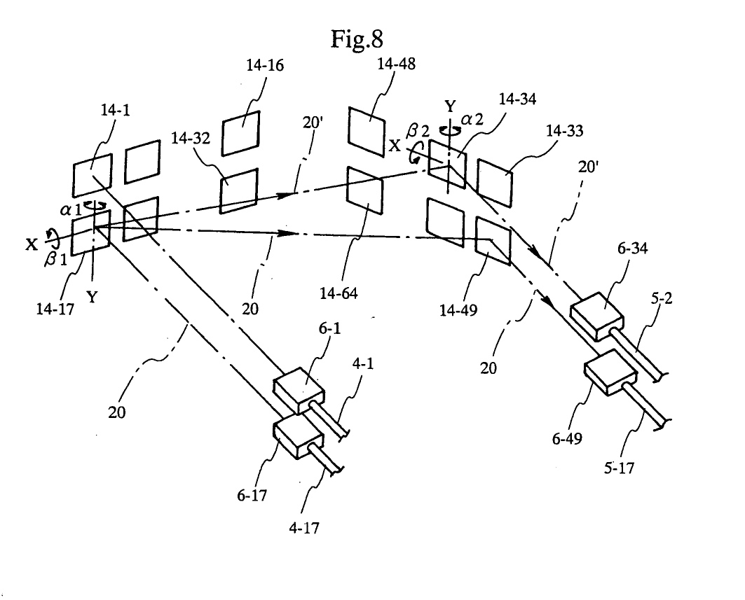

Now, the optical path of the optical switch 1 will be described with reference to FIG. 8. Here, the description is made with respect to a single optical path for the sake of convenience.

Light emitted from an optical fiber 4-17 for input is made parallel light by a collimating lens 6-17, and the incident light 20 is entered into a corresponding mirror 14-17. The reflected light 20 from the mirror 14-17 is entered into a corresponding mirror 14-49, then entered into a collimating lens 6-49, and entered into an optical fiber 5-17 for output to propagate through the optical fiber 5-17.

Here, an explanation is made on the case where light emitted from the optical fiber 4-17 is outputted by switching an optical fiber from the optical fiber 4-17 to an optical fiber 5-2. Light emitted from an optical fiber 4-17 for input is made parallel light by a collimating lens 6-17, and the incident light 20 is entered into a corresponding mirror 14-17. At this time, the reflected light is rotated in a horizontal plane by rotating the mirror 14-17 by α1 about the Y-axis, which is a vertical direction, and further it is rotated in the vertical direction by rotating the mirror 14-17 by β1 about the horizontal axis. Thereby, the path of the reflected light 20′ from the mirror 14-17 can be switched so that the reflected light 20′ heads toward a mirror 14-34 instead of mirror 14-49. Furthermore, by rotating the mirror 14-34 itself by α2 about the Y-axis and by β2 about the X-axis, the reflected light 20′ is entered into the collimating lens 6-34, and then entered into the optical fiber 5-2 for output to propagate through the optical fiber 5-2.

In this manner, the path of light entered from thirty-two optical fibers 4 on the input side can be switched by selecting an arbitrary optical fiber 5 from among the thirty-two optical fibers 5 on the output side. Thus the optical switch 1 is configured.

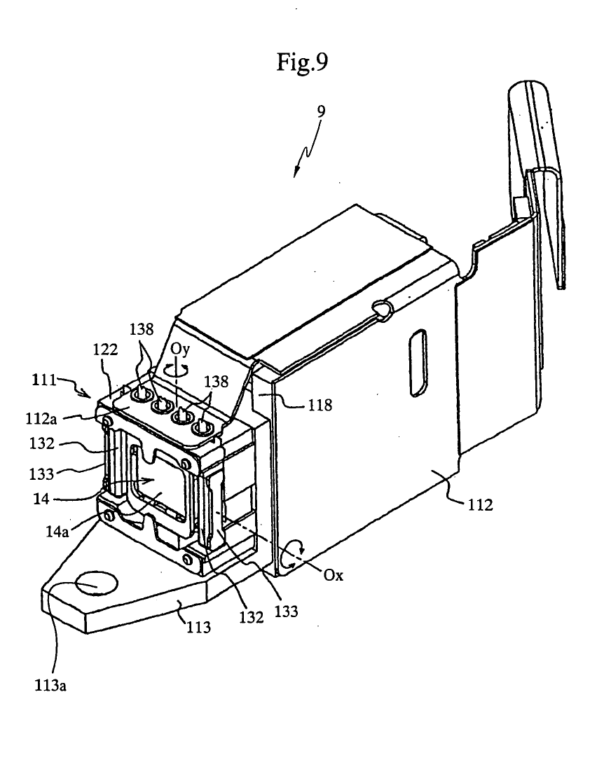

The galvano-mirror 9 is now explained with reference to FIGS. 9 to 11.

The galvano-mirror 9 according to this embodiment includes an optical deflector 111 having a mirror 14, flexible printed circuit (FPC) 112, housing 113, semiconductor laser 114, polarizing beam splitter (PBS) 115, ¼ wavelength plate 116, converging lens 117, semiconductor position sensitive detector (PSD) 118, and spacer 119.

The deflector 111 has a coil holder 121 serving as a movable section, and a magnet holder 122 serving as a fixing section. In the coil holder 121 and magnet holder 122, the both ends of four springs 123 made of beryllium copper are held by insert molding their end portions on the movable section side and their end portions on the fixing section side, respectively, into the coil holder 121 and the magnet holder 122.

Thus, at their both ends, the four springs 123 are fixed by the coil holder 121 and the magnet holder 122, and support the coil holder 121 with respect to the magnet holder 122 so as to be inclinable about the rotational axes X and Y.

Each of the mirrors 14 is fixed to a mounting section 121a located in the central portion on the surface side of the coil holder 121, by positioning and adhering its peripheral portion. The reflecting surface 14a of the mirror 14, on the front side, is coated with gold or a dielectric multilayer that exhibits a high reflectance with respect to light with a wavelength of light for optical communications, e.g., light with a wavelength of 1.3 to 1.6 μm.

A mirror 125 constituting an inclination sensor for the mirror 14 is fixed to the central portion on the rear surface side of the coil holder 121, by positioning and adhering its peripheral portion.

A first coil 127 and second coil 128 are adhered and fixed to the coil holder 121 after positioning, on the surface side and rear surface side of the coil holder 121, respectively, with the mirror 14 and mirror 125 between the first and second coils.

In a spatial portion between the two mirrors 14 and 125, the central portion of an arm 129, serving as a first support member, formed by bending, for example, a stainless steel plate with a thickness of 0.1 mm is located, and the central portion is adhered and fixed to the magnet holder 121 by arranging the both end portions 129a of the arm 129 to surround the outer periphery of the mirror 125. In the central portion of the arm 129, there is provided a cone-shaped projection with a hole 129b formed in the center so as to be located apart by, e.g., 0.2 mm from the rear surface of the mirror 14, and after a damping agent such as silicone rubber has been injected between the projection 129b and the mirror 14, it is cured, thereby forming a pivot (not shown).

To the magnet holder 122, two magnets 132 for the first coil 127 and two magnets 135 for the second coil 128 are fixed, upon adhering yokes 133 and 134 to their respective rear surfaces.

The optical deflector 111 is fitted to two holes formed in the mounting surface 113a of the housing 113, and adhered to the mounting surface 113a after positioning.

In order to detect the inclination angle of the mirror 14 from that of the mirror 125, the semiconductor laser 114, PBS 115, ¼ wavelength plate 116, converging lens 117, and PSD 118 are mounted to the housing 113. The semiconductor laser 114 is mounted to an opening 113b of the housing 113; the PBS 115 has its one surface adhered to a pedestal of the housing 113; the ¼ wavelength plate 116 is joined to the PBS 115; the converging lens 117 is fixed to an opening 113c formed in the mounting surface 113a of the optical deflector 111 of the housing 113, and the PSD 118 is adhered to the housing 113.

The PSD 118 is a two-dimensional position sensitive detector that outputs the bidirectional light quantity central position of light projected onto its light-receiving section 118a, and its examples include S5990-01 and S7848-01 produced by Hamamatsu Photonics Corp.

The FPC 112 includes a circuit for converting the output current of the PSD 118 into the output voltage, and a drive circuit 151 for the first coil 127 and the second coil 128. Here, the drive circuit 151 is fixed by causing its surface to abut against aluminum-made spacer 119 fixed on the top surface of the PBS 115 of the housing 113. Thereby, the spacer 119 and the housing 113 are caused to serve also as heat-dissipating members for the drive circuit.

In the galvano-mirror 9 with such configurations, once a current has been applied to the first coil 127 through two of four springs 123, the movable section generates a torque about the rotational axis Y due to a magnetic field received from the magnets 132, and thereby the four springs 123 undergo deflective deformation, so that the movable section comes to incline about the rotational axis Y.

Also, once a current has been applied to the second coil 128 through the other two out of the four springs 123, the movable section generates a torque about the rotational axis X due to a magnetic field received from the magnets 135, and thereby the four springs 123 undergo deflective deformation, so that the movable section comes to incline about the rotational axis X.

On the other hand, light from the semiconductor laser 114 enters the PBS 115 as P-polarized light, and after having passed through its polarization plane 115a, enters the rear surface (reflecting surface) of the mirror 125 through the ¼ wavelength plate 116 and the converging lens 117. The light reflected from the mirror 125 enters the PBS 115 through the converging lens 117 and the ¼ wavelength plate 116.

Here, since the light that enters the PBS 115 after having been reflected from the mirror 125, passes through the ¼ wavelength plate 116 twice in total in the forward and return paths, the polarization plane of the PBS 115 rotates 90 degrees, so that the light becomes S-polarized light. As a result, the light is reflected from the polarization plane 115a of the PBS 115, and enters the light-receiving surface 118a of the PSD 118.

When inclining the mirror 14, and hence, the mirror 125 about the rotational axis Y by applying a current to the first coil 127, the above-described light having entered the light-receiving surface 118a of the PSD 118 laterally moves on the light-receiving surface 118a. Also, when inclining the mirror 14 about the rotational axis X by applying a current to the second coil 128, the above-described light vertically moves on the light-receiving surface 118a. Therefore, the bidirectional inclinations of the mirror 14 can be detected based on the output of the PSD 118.

The above-described arrangements of the galvano-mirror 9 allows the mirror 14 to be supported and driven so as to be inclinable about the two axes, and provide an inclination sensor for sensing the inclinations of the mirror 14 about the two axes. By inclining the mirror 14 to change and control the direction of the reflection of light from the optical fiber 4 using these support and drive mechanism for the mirror 14 and inclination sensor, it is possible to switch among the output optical fibers as described above.

The described configurations of the present invention produce the following effects.

Since the galvo plate 7B is caused to abut against the base plate 2 on its mounting sections 7B-a at the both ends, and in addition, the abutting sections 7B-c formed at portions near galvano-mirrors 9 are also caused to abut against the base plate 2, heat transfer from the galvo-plate 7B to the base plate 2 is improved, and heat of the galvano-mirrors 9, particularly heat in their drive circuit 151 and laser 114, can be dissipated to the base plate 2. Furthermore, since abutting sections 7B-c are provided at respective portions near the sixteen galvano-mirrors 9, the heat dissipation characteristics of the respective galvano-mirrors 9 can be improved, thereby allowing the reduction in temperature rise of the laser 114.

The two-tiered galvo plates 7A and 7B are caused to abut against each other on the mounting surfaces at their both ends, and in addition, the abutting sections 7B-d and 8A-c that are facing each other and disposed adjacent to the respective galvano-mirrors 9 between the galvo plates 7A and 7B, are also caused to mutually abut against. As a result, heat generated in the galvano-mirrors 9 in the galvo plate 7A on the upper side can be dissipated to the base plate 2 through the abutting sections 7B-d and 8A-c as well as through the mounting sections 7A-a and 7B-b at the both ends, and via the galvo plate 7B on the lower side.

The upper end of each of the studs 17 is not in contact with the rear surface of the galvo plate 7A with a little space therebetween, and therefore, when the galvo plate 7A is fixed to the base plate 2, there is no possibility that the galvo plate is deformed by errors in the height position of the studs 17.

As described above, the mounting surfaces 7A-a at the both ends of the galvo plate 7A and the bottom surfaces of the twelve abutting sections 7A-c thereof are mutually flush, and the mounting surfaces 7A-b at the both ends and the top surfaces of the twelve abutting sections 7A-d thereof are also mutually flush. Therefore, when machining the mounting surfaces 7A-a at the both ends of the galvo plate 7A and the bottom surfaces of the twelve abutting sections 7A-c thereof, and the mounting surfaces 7A-b at the both ends of the galvo plate 7A and the top surfaces of the twelve abutting sections 7A-d thereof, they can be each machined to high flatness. This allows the contact conditions between the galvo plate B and the base plate 2, and those between the galvo plates A and B to become superior, thereby improving the thermal conduction therebetween.

Since a plurality of galvano-mirrors are provided to a single galvo plate, and an optical switch is formed by using the plurality of galvano-mirrors, galvano-mirrors produced for every optical switch can be easily gathered, thereby allowing an multi-channelized optical switch to be easily formed.

Interposing a conductive member having good conductivity, such as thermal interface silicone rubber, between the abutting sections between the galvo plate 7B and the base plate 2, and between the abutting sections between the galvo plates 7A and 7B, would provide excellent heat dissipation characteristic.

The optical path changing element is not limited to the inclinable mirror described above but may include other optical elements, such as lenses, prisms, and the like that performs the required functions. Also, the construction of the galvano-mirror is not restricted to that described above but may include other constructions.

The configuration of the galvo plate is not limited to the two-stage type described above but may include other configurations. Also, the driving system is not restricted to coils and magnets as described above but may include other driving methods, such as electrostatic drive, drive by an piezoelectric element, and the like. Furthermore, the supporting means is not limited to the beryllium copper spring described above but may include other things, such as silicone spring, link, and the like that perform the required functions.

In this invention, it is obvious that widely different embodiments of this invention may be made on the basis thereon without departing from spirit and scope thereof. This invention is not limited to the specific embodiments thereof except as defined in the appended claims.

1. An optical switch comprising:
a first plate having first mounting surfaces and first abutting surfaces that are provided on a first side;
a second plate having second mounting surfaces and second abutting surfaces that are provided on a second side, each of the second mounting surfaces abutting against a respective one of the first mounting surfaces and each of the second abutting surfaces abutting against a respective one of the first abutting surfaces to fix the first plate and the second plate; and
a plurality of optical path selecting elements mounted on the first plate and the second plate.

2. The optical switch according to claim 1, wherein the first mounting surfaces and the first abutting surfaces are mutually flush, and wherein the second mounting surfaces and the second abutting surfaces are mutually flush.

3. The optical switch according to claim 1, wherein the first mounting surfaces are disposed on the both ends of the first plate, and wherein the first abutting surfaces are disposed between the first mounting surfaces disposed on the both ends of the first plate.

4. The optical switch according to claim 1, further comprising coupling members for coupling the first plate and the second plate, wherein one end of each of the coupling members is mounted on the first plate, and the other end of each of the coupling members is located apart from the second plate.

5. The optical switch according to claim 4, wherein the coupling members are fixing members for fixing the optical path selecting elements to the first plate.

6. The optical switch according to claim 1, wherein the optical path selecting elements are each a galvano-mirror.

7. The optical switch according to claim 1, wherein the optical switch comprises at least two the first plates and the second plates respectively.

8. The optical switch according to claim 1, wherein the optical switch comprises optical fibers corresponding to the plurality of optical path selecting elements.

9. The optical switch according to claim 8, wherein the optical fibers comprise an optical fiber for input and an optical fiber for output, and light emitted from the optical fiber for input is entered into the optical fiber for output via one of the plurality of optical path selecting elements and further via another one of the plurality of optical path selecting elements.

10. The optical switch according to claim 9, wherein the optical path selecting elements are controlled to select the optical fiber for output.

11. The optical switch according to claim 6, wherein the galvano-mirror has an inclination sensor.

12. The optical switch according to claim 11, wherein the inclination sensor is a sensor of optical type.
